(19) United States
(12) Patent Application Publication
(10) Pub. No.: US 2024/0211961 A1
(43) Pub. Date: Jun. 27, 2024

(54) SYSTEM AND METHOD FOR MANAGING ISSUES USING KNOWLEDGE BASE METADATA

(71) Applicant: Dell Products L.P., Round Rock, TX (US)

(72) Inventors: ANNE MARIE MCREYNOLDS, San Jose, CA (US); SHEILA WILLIAMS PHINAZEE, Wake Forest, NC (US)

(21) Appl. No.: 18/145,063

(22) Filed: Dec. 22, 2022

(51) Int. Cl. G06Q 30/015; G06N 5/022

(52) U.S. Cl. CPC G06Q 30/015; G06N 5/022

(57) ABSTRACT

Methods and systems for managing customer-encountered issues are disclosed. To manage the customer-encountered issues, service requests for the customer-encountered issues may be managed to reduce time to resolution. To do so, potential processes for remediating the customer-encountered issues may be searched using a two step procedure. The two step procedure may include both keyword searching to broadly identify relevant articles and ranking of the identified relevant articles. The ranking process may take into account both past history of resolution process success and availability of metadata for the resolution processes.

### FIELD

Embodiments disclosed herein relate generally to issue management. More particularly, embodiments disclosed herein relate to systems and methods to manage issues using knowledge base metadata.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show diagrams illustrating data flows, processes, and other aspects of a system in accordance with an embodiment.

FIG. 3A shows a flow diagram illustrating a method of remediating a customer-encountered issue in accordance with an embodiment.

FIG. 3B shows a flow diagram illustrating a method of updating operation of a remediation recommendation system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing customer-encountered issues. To manage the customer-encountered issues, service requests for the customer-encountered issues may be serviced by service agents. To do so, information that may be relevant to resolve the customer-encountered issues may be identified. For example, information regarding past resolutions of customer-encountered issues may be stored in a knowledge base.

To identify the most relevant information, a two part search strategy may be employed. In a first part of the search strategy, keyword searching of the body of articles (e.g., regarding resolution processes) based on the customer-encountered issues may be performed. This first part of the search strategy may return many results which may be beyond the capacity of a service agent to review and use to resolve the customer-encountered issues.

In a second part of the search strategy, the search results (e.g., some of the articles from the knowledge base) may be ranked based on a quality of metadata for the articles, utilization of the articles in attempts to address customer-encountered issues, and accuracy (i.e., whether successfully resolved using the articles) of the articles in the attempts to resolve the customer-encountered issues. The ranking may be used to define an ordering of review and or utilization by the service agents for resolving the customer-encountered issues.

By implementing the two part search strategy, more relevant articles may be more quickly presented to service agent thereby reducing a time to resolution of the service requests.

To prepare to resolve customer-encountered issues in the future, the resolved service request and information regarding the resolution process may be used to update the metadata regarding the articles. Doing so may improve ease of search and use of the articles.

By doing so, a system in accordance with embodiments disclosed herein may reduce the duration of time to resolve customer-encountered issues. Accordingly, the aggregate quantity of resources expended to resolve issues may be reduced.

Thus, embodiments disclosed herein may address the technical problem of resource limitations in response management systems. Due to limited availability of resources, only certain numbers and types of remediation processes may be implemented per unit time. By ranking remediation processes described by knowledge base articles, embodiments disclosed herein may reduce the suffering of the customers subject to the customer-encountered issues through reduced time to resolution and may improve the capacity of customer-encountered issues that may be reduced per unit time.

In an embodiment, a method for managing customer-encountered issues is disclosed. The method may include obtaining a service request for a customer-encountered issue of the customer-encountered issues; obtaining a portion of knowledge base articles that are responsive to a keyword search based on the customer-encountered issue; ranking the portion of the knowledge base articles based, at least in part, on a quality score of metadata for each knowledge base article of the portion of knowledge base articles to obtain a ranked order; and resolving the service request using the portion of the knowledge base articles and the ranked order.

The method may also include, for one of the knowledge base articles of the portion of the knowledge base articles: comparing metadata for the one of the knowledge base articles to an enumerated list of metadata fields to identify a portion of the metadata fields that are present in the metadata; calculating a sub-score for each metadata field of the portion of the metadata fields; and using the sub-scores for the metadata field to obtain the quality score for the one of the knowledge base articles of the portion of the knowledge base articles.

The metadata fields may include at least one selected from a list of metadata fields consisting of: a title, a creator, a subject, a description, a publisher, a date, a format, and identifier, a language, and rights.

Ranking the portion of the knowledge base articles may include, for the one of the knowledge base articles of the portion of the knowledge base articles: calculating a ranking score for the one of the knowledge base articles based on the quality score, a use rate score for the one of the knowledge base articles, and an accuracy score for one of the knowledge base articles; and ordering the one of the knowledge base articles with respect to other knowledge base articles of the portion of the knowledge base articles based on the ranking score and ranking score of the other knowledge base articles.

Resolving the service request may include prompting a service agent to review the portion of the knowledge base articles in an order specified by the ranked order.

Resolving the service request may also include, after the customer-encountered issue is resolved using a second one of the knowledge base articles of the portion of the knowledge base articles: documenting a process performed to resolve the customer-encountered issue based on the second one of the knowledge base articles; and updating a portion of the metadata that is for the second one of the knowledge base articles based on the customer-encountered issue to obtain updated metadata.

Updating the portion of the metadata may include adding a problem statement to the portion of the metadata, the problem statement comprising terminology used by a customer to initiate the service request.

A non-transitory media may include instructions that when executed by a processor cause the computer-implemented method to be performed.

A data processing system may include the non-transitory media and a processor, and may perform the computer-implemented method when the computer instructions are executed by the processor.

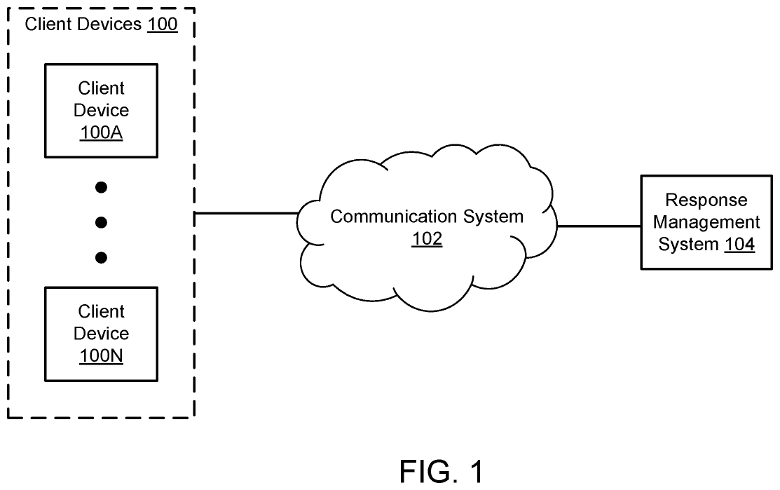

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, and/or any other type of service that may be implemented with a computing device.

To provide the computer-implemented services, the system may include any number of client devices 100. Client devices 100 may provide the computer implemented services to users of client devices 100 and/or to other devices (not shown). Different client devices (e.g., 100A, 100N) may provide similar and/or different computer implemented services.

To provide the computer-implemented services, client devices 100 may include various hardware components (e.g., processors, memory modules, storage devices, etc.) and host various software components (e.g., operating systems, application, startup managers such as basic input-output systems, etc.). These hardware and software components may provide the computer-implemented services via their operation.

To provide certain computer-implemented services, the hardware and/or software components may need to operate in predetermined manners. If the hardware and/or software components do not operate in the predetermined manners, then a client device may be unable to provide all, or a portion, of the computer-implemented services that it normally provides.

The hardware and/or software components of client devices 100 may operate differently (e.g., in an undesirable manner) from the predetermined manners for any number of reasons. For example, any of the hardware and/or software components may malfunction. In another example, the hardware and/or software components may be operating nominally but in undesirable manners through various interactions such as resource conflicts or constraints. In a further example, various configuration settings of the hardware and/or software components may be set (intentionally or inadvertently) in a manner that causes the operation of any of client devices 100 to be undesirable. The hardware and/or software components of client devices 100 may operate different from the predetermined manners for other reasons (e.g., various root causes) without departing from embodiments disclosed herein. Thus, a client device may not provide its computer-implemented services for any number of reasons which may be difficult to identify.

The undesired operation of client devices 100 may take any number of forms which may be linked to a root cause of the undesired operation. For example, an undesired operation of a client device may be a lack of operation such as failing to power on when a power button is depressed. In another example, an undesired operation of a client device may be a failure of the client device to utilize a full width of a display when presenting information to a user via the display. In a further example, an undesired operation of a client device may be inconsistent operation of the client device over time such as the client device intermittently freezing for periods of time during which the client device is unresponsive to a user and/or other devices. The undesired operation of client devices 100 may manifest in other manners without departing from embodiments disclosed herein. Thus, a client device may manifest any number of undesired operations which may be due to any number of root causes.

To improve the likelihood of client devices 100 providing desired computer implemented services, the system of FIG. 1 may include response management system (RMS) 104. RMS 104 may be tasked with addressing undesired operation of any of client devices 100. However, RMS 104 may have limited resources with which to address the undesired operation of client devices 100.

In general, embodiments disclosed herein may provide methods, systems, and/or devices for managing an undesired operation of client devices 100. To manage the undesired operation of client devices 100, RMS 104 may provide remediation services to address the undesired operation of client devices 100. The remediation services may take into account past attempts at remediating similar issues when deciding on how to use limited resources for resolving client issues. To take into account past attempts at remediation of similar issues, metadata for documentation (e.g., knowledge base articles) regarding the past remediations may be (i) automatically generated in a regimented manner to establish a uniform metric for rating the documentation, and (ii) used to suggest which portions of documentation regarding the past remediations should be considered before other documentation when attempting to remediate customer-encountered issues with respect to clients 100. By leveraging metadata for documentation of past remediations, RMS 104 may marshal its limited resources in a manner that reduces the time to resolve customer-encountered issues and reduces the future resource cost for resolving customer-encountered issues in the future.

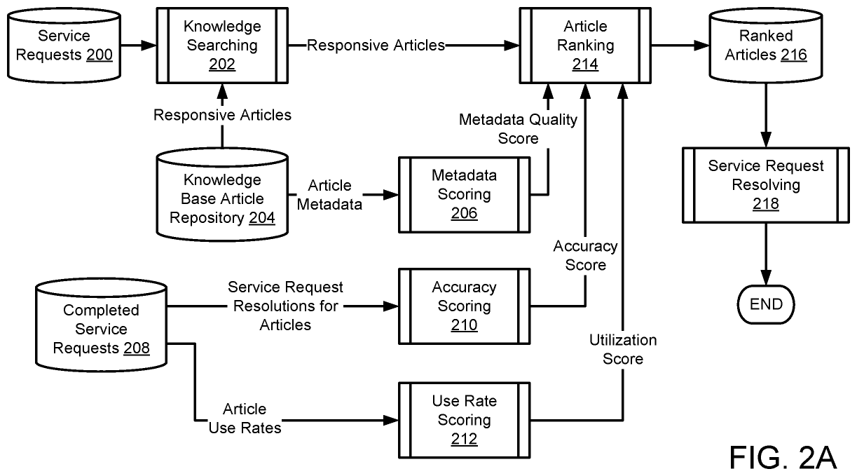

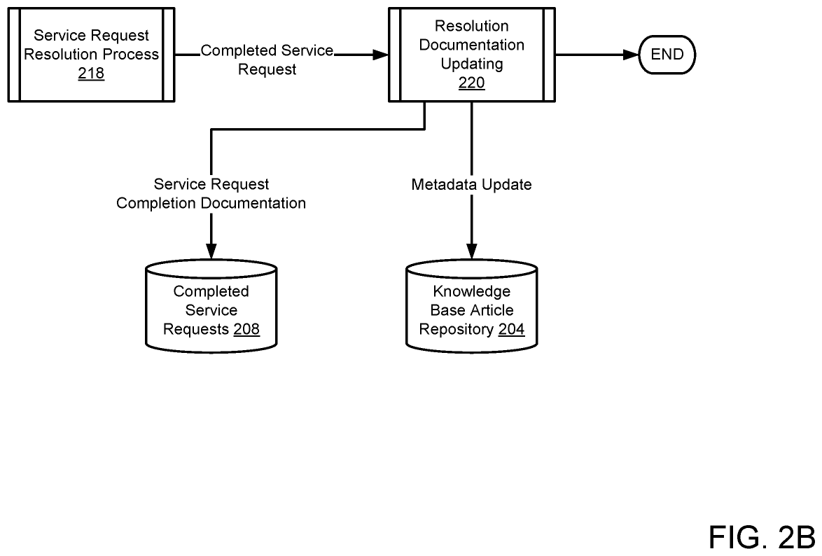

To provide the remediation services, RMS 104 may (i) receive information from users of client devices 100 regarding various customer-encountered issues (e.g., undesired operation of client devices 100 encountered by users thereof) with respect to client devices 100, (ii) establish service requests based on the customer-encountered issues, (iii) obtain a set of search results (e.g., also referred to as “relevant knowledge base articles”) of available knowledge base articles using keyword searching based on the service requests for each of the service requests, (iv) for each service request, rank the set of search results based on a metadata score for each relevant knowledge base article, a use rate score for each relevant knowledge base article, and an accuracy score for each relevant knowledge base article, and/or (v) for each service request, use the ranking and the set of knowledge base articles to remediate the corresponding customer-encountered issue (e.g., to resolve the customer-encountered issue). Refer to FIG. 2A for additional details regarding remediating client encountered issues.

To prepare to provide the remediation services, RMS 104 may, after a customer- encountered issues has been resolved, (i) document the process for resolving the customer-encountered issue, and (ii) automatically update metadata for a knowledge base article that contributed to the resolution of the customer-encountered issue. The metadata may be updated based on the customer-encountered issue, thereby allowing knowledge base articles that document processes for resolving the customer-encountered issue to automatically be identified via metadata searching (e.g., rather than through keyword searching of the knowledge base articles). For example, a knowledge base article may be stored in a webpage (or other) viewable format, and may include content regarding, for example, a customer-encountered issue, a process for resolving a customer-encountered issue, etc. In contrast, the metadata for the knowledge base article may include information regarding the knowledge base article. Refer to FIG. 2B for additional details regarding preparing to provide remediation services.

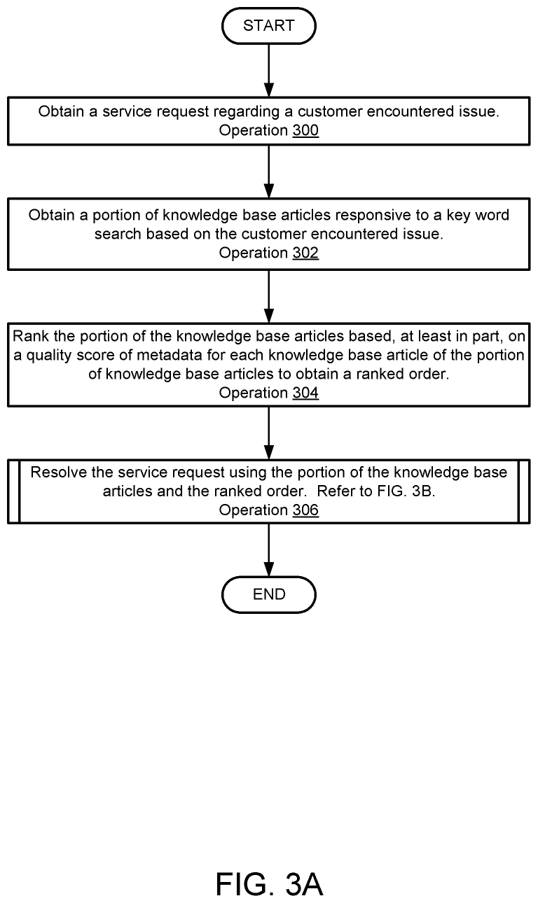

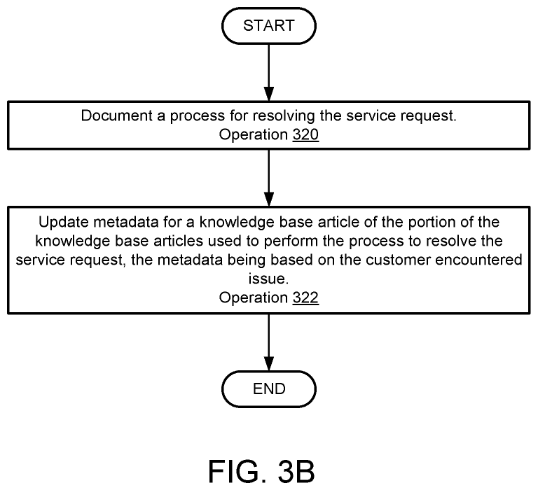

When providing its functionality, RMS 104 may perform all, or a portion, of the methods illustrated in FIGS. 3A-3B.

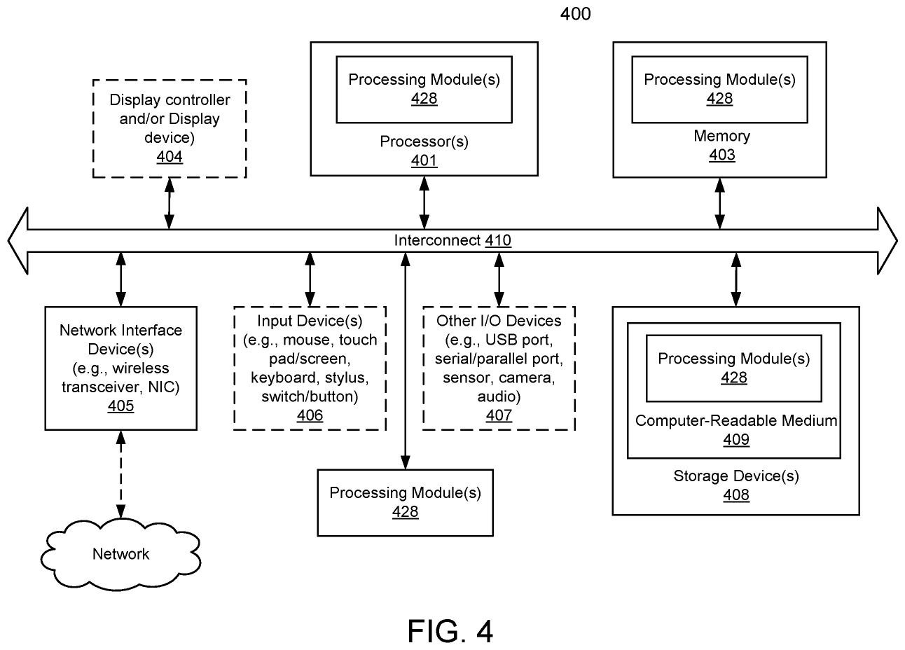

Any of client devices 100 and/or RMS 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

RMS 104 may be implemented with multiple computing devices. The computing devices of RMS 104 may cooperatively perform processes for managing customer-encountered issues. The computing devices of RMS 104 may perform similar and/or different functions, and may be used by different persons that may participate in the management of the customer-encountered issues. For example, RMS 104 may include multiple computing devices used by different service agents (e.g., persons) tasked with resolving customer-encountered issues. The service agents may attempt to utilize knowledge base articles to resolve the customer-encountered issues.

RMS 104 may be maintained, for example, by a business or other entity that has some degree of responsibility with respect to maintaining the operation of client devices 100. For example, RMS 104 may be operated by a business that sells client devices 100 and provides warranty or other types of support for client devices 100 to users and/or owners thereof.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as included a limited number of specific components, a system in accordance with an embodiment may include fewer, additional, and/or different components than those illustrated therein.

To further clarify embodiments disclosed herein, diagrams illustrating data flows implemented by and data structures used by a system over time in accordance with an embodiment are shown in FIGS. 2A-2B. In FIGS. 2A-2B, data structures are represented using a first set of shapes (e.g., 200, 204, 208, 216) and processes are represented using a different set of shapes (e.g., 202, 206, 210, 212, 214, 218, 220).

Turning to FIG. 2A, a data flow diagram illustrating data flows, data processing, and/or other operations that may be performed by RMS 104 in accordance with an embodiment is shown.

To manage customer-encountered issues, RMS 104 may obtain service requests 200. Service requests 200 may be data structures that include information regarding the customer-encountered issues. Service requests 200 may be obtained by (i) obtaining information regarding the customer-encountered issues and (ii) adding the obtained information to a new or existing data structure representing a service request. The information may be obtained, for example, by (i) receiving the information via a portal (e.g., a website), (ii) receiving the information via phone calls, video calls, instant messages, and/or via other types of interactions with users (which may be subsequently subjected to processing to derive recordable information regarding the user and the customer encounter issue), and/or (iii) via other methods.

Once a service request is created, the customer-encountered issue associated with a service request may be used to identify relevant knowledge base articles via knowledge searching 202. Knowledge searching 202 may include keyword searching of knowledge base articles (e.g., stored in knowledge base article repository 204) based on the corresponding customer-encountered issue. For example, the keyword searching may search the body of the knowledge base articles for keywords derived from the corresponding customer-encountered issue. Knowledge searching 202 may return any number of responsive articles.

However, depending on the quality of the knowledge base articles, the usefulness of the responsive articles with respect to remediating the customer-encountered issue may be highly variable. Mere descriptions of customer-encountered issues when used for keyword searching may not return useful knowledge base articles, and the prevalence of the search terms in the knowledge base articles may not be correlated with more useful knowledge base articles.

For example, knowledge base articles may not focus on problems encountered by users of client devices, and may not use terminology likely used by the users of the client devices to describe the customer-encountered issues. In another example, if limited terminology and/or Boolean logic is implemented for searching, the search results may be polluted with large amounts of irrelevant search results. In a further example, even if keyword searching is supplemented with metadata analysis, the metadata for knowledge base articles typically focuses on reviews of knowledge base articles or irrelevant information with respect to resolving customer-encountered issues.

To improve the quality of knowledge base articles with respect to the customer-encountered issue, article ranking 214 may be performed. Article ranking 214 may include (i) calculating a numerical value (e.g., a score) and (ii) establishing an ordering for the responsive article based on the numerical scores corresponding to the articles.

The numerical score for each article may be calculated by dividing an accuracy score for the article by a utilization (e.g., use score) for the article, and adding a quality score (which may be normalized) score to obtain a sum. The sum may then be normalized (e.g., divided by two). For example, numerically the following formula may be used: f(U, A, Q)=(A/U+Norm(Q))/2, where U is the utilization score for the article, A is the accuracy score for the article, Q is a quality score for metadata for the article, and 2 is used to normalize the sum (may be other values, depending on whether other terms are taken into account).

The metadata quality score may be obtained via metadata scoring 206. Metadata scoring 206 may include identifying the metadata associated with an article, comparing the metadata to an enumerated list of specific types of metadata, and using a scoring system to calculate the metadata quality score by summing a point value (e.g., specified by the scoring system) for each portion of metadata in the enumerated list of specific types of metadata that are present for the article (e.g., may be stored as part of knowledge base article repository 204, or may be stored separately).

The enumerated list of metadata may include any number of fields. For example, the fields may include fields for titles (e.g., of the articles), creators (of the articles), subjects, descriptions, publishers, dates, formats, identifiers, languages, and rights.

The scoring system may specify that some of the metadata fields, if present and filled, may be ascribed one point for the fields creator, publisher, format, and identifier. The scoring system may ascribe two points for the fields title, subject, description, date, language, and rights. Thus, if all of the enumerated fields are present, 16 points may be ascribed. The ascribed point total may then be normalized (e.g., by dividing by 16) so that the value of the metadata score is between 0 and 1, with 1 representing all of the metadata fields in the enumerated list being present in the metadata for an article.

The accuracy score for the article may be obtained via accuracy scoring 210. Accuracy scoring 210 may include (i) identifying service requests (e.g., from completed service requests 208) that have been marked complete and that indicate that the service request was resolved using the article, and (ii) using the number of identified service requests as the accuracy score.

The utilization score for the article may be obtained via use rate scoring 212. Use rate scoring 212 may include (i) identifying service requests (e.g., from completed service requests 208) that reference the article (but that do not necessary indicate that the article resolved the service request), and (ii) using the number of identified service requests as the utilization score.

Once numerical scores for each of the responsive articles are obtained, ranked articles 216 may be obtained. Ranked articles 216 may specify an order with respect to the relevant articles.

Ranked articles 216 may be used during service request resolving 218 to resolve the service requests. For example, ranked articles 216 may be used to present the responsive articles in a particular order (e.g., highest ranked to lower ranked) to service agents tasked with remediating the service requests, the ordering of the articles may be presented to the service agents, and/or the service agents may otherwise use the ranked articles to perform processes to attempt to resolve the customer-encountered issues.

Once a service request is resolved, information regarding the resolution process may be used to update the knowledge base article repository 204 (and/or the metadata for the articles, depending on whether the metadata is part of repository 204 or a separate data structure). Complete service requests 208 may also be updated based on the resolved service request. Refer to FIG. 2B for additional details.

Turning to FIG. 2B, a data flow diagram illustrating data flows, data processing, and/or other operations that may be performed by RMS 104 in accordance with an embodiment is shown. The processes illustrated in FIG. 2B may be used to prepare to resolve future service requests.

Once a service request has been resolved, the completed service request and information regarding the resolution process may be used to drive resolution documentation updating 220. During resolution documentation updating 220, the completed service requests may be stored in completed service requests 208 (e.g., a repository) along with information regarding the knowledge base articles that (i) were attempted to be used to resolve the service request but did not succeed and (ii) were used and successfully resolved the service request. For example, completed service requests 208 may be updated with the addition of service request completion documentation. The service request completion documentation may include the information regarding the completed service request, the process, associations to the articles from knowledge base article repository 204, and/or other information.

Similarly, during resolution documentation updating 220, a portion of metadata associated with the article that was used to successfully resolve the service request may be updated. The portion of metadata may be updated to indicate that the client encountered issue was resolved using the article. For example, the portion of metadata may be updated to indicate and/or include a problem statement using terminology used by a customer that initiated the service request. In this manner, both knowledge base articles and corresponding service requests relating to a similar customer-encountered issue may be identified. For example, the metadata associated with articles may be searched to identify an article. The article may then be used to search completed service requests 208 to identify the completed service requests associated with the customer-encountered issue.

By doing so, the next time that a service request for a similar customer-encountered issue is received, the description of the customer-encountered issue may be used to search both repositories (e.g., 204, 208) to identify information more likely to be usable to resolve the service request. Thus, embodiments disclosed herein may provide a system for managing a knowledge base system in a manner that more efficiently allows for information from the knowledge base that is relevant to resolving a customer-encountered issue to be identified.

In an embodiment, RMS 104 is implemented using a hardware device including circuitry. The hardware device may be, for example, a digital signal processor, a field programmable gate array, or an application specific integrated circuit. The circuitry may be adapted to cause the hardware device to perform the functionality of RMS 104 such as knowledge searching 202, metadata scoring 206, accuracy scoring 210, use rate scoring 212, article ranking 214, service request resolving 218, and resolution documentation updating 220, and/or other processes. RMS 104 may be implemented using other types of hardware devices without departing embodiment disclosed herein.

In one embodiment, RMS 104 is implemented using a processor adapted to execute computing code stored on a persistent storage that when executed by the processor performs the functionality of RMS 104 discussed throughout this application such as knowledge searching 202, metadata scoring 206, accuracy scoring 210, use rate scoring 212, article ranking 214, service request resolving 218, and resolution documentation updating 220, and/or other processes. The processor may be a hardware processor including circuitry such as, for example, a central processing unit, a processing core, or a microcontroller. The processor may be other types of hardware devices for processing information without departing embodiment disclosed herein.

In an embodiment, RMS 104 includes storage which may be implemented using physical devices that provide data storage services (e.g., storing data and providing copies of previously stored data). The devices that provide data storage services may include hardware devices and/or logical devices. For example, storage may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage may include a memory device (e.g., a dual in line memory device) in which data is stored and from which copies of previously stored data are provided. In another example, storage may include a persistent storage device (e.g., a solid-state disk drive) in which data is stored and from which copies of previously stored data is provided. In a still further example, storage may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

Storage may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

The storage may store data structures including service requests 200, knowledge base article repository 204, completed service requests 208, and ranked articles 216. Any of these data structures may be implemented using, for example, lists, tables databases, linked lists, unstructured data, and/or other types of data structures.

As discussed above, the components of FIG. 1 may perform various methods to manage customer-encountered issues. FIGS. 3A-3B illustrate methods that may be performed by the components of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of resolving customer-encountered issues in accordance with an embodiment is shown. The method may be performed by RMS 104 or other components of the system shown in FIG. 1.

At operation 300, service requests regarding customer-encountered issues are obtained. The service requests may be obtained by reading them from storage, receiving them from other devices, and/or by generating them. To generate the service requests, information regarding the customer-encountered issue may be collected (e.g., via a portal and/or other communication medium). The information may be used to generate the service requests via, for example, population of a data structure with the information. The information may include any type and quantity of information regarding the customer-encountered issue. The customer-encountered issue may relate, for example, to a computing device for which RMS 104 provides management services that may facilitate resolution of the customer-encountered issues.

At operation 302, a portion of knowledge base articles responsive to a keyword search based on the customer-encountered issue is obtained. The portion of the knowledge base articles may be obtained by performing a keyword search based on the customer-encountered issue. The keyword search may search the bodies of the knowledge base articles for the keywords. The keyword search may not search the metadata associated with the knowledge base articles. The search may return the portion of the knowledge base articles.

At operation 304, the portion of the knowledge base articles is ranked based, at least in part, on a quality score of metadata for each knowledge base article of the portion of the knowledge base articles to obtain a ranked order. The portion of the knowledge base articles may be ranked by (i) calculating a numerical score for each knowledge base articles (e.g., as discussed with respect to FIG. 2A), and (ii) obtaining the ranked order using the numerical scores.

At operation 306, the service request is resolved using the portion of the knowledge base articles and the ranked order. The service request may be resolved by (i) presenting the knowledge base articles in the ranked order to a service agent assigned to resolve the service request, (ii) providing the portion of the knowledge base articles and the ranked order to the service agent, and/or (iii) otherwise using the ranked order to drive use of the portion of the knowledge base articles to resolve the service request.

For example, each of the knowledge base articles of the portion of the knowledge base articles may be presented to the service agent in the ranked order, requesting that the service agent indicate whether each presented article resolved the customer-encountered issue, and, if not resolved, continue the presentation process by presenting a different but lower ranked article to the service agent until the customer-encountered issue is resolved.

The service request may be resolved using the method illustrated in FIG. 3B and through which information regarding the current resolution may be used to expedite resolution of future customer-encountered issues.

The method may end following operation 306.

Using the method illustrated in FIG. 3A, a system in accordance with an embodiment may be more likely to present relevant information to service agents tasked with resolving customer-encountered issues through (i) use of a broad search technique (e.g., keyword) and (ii) a ranking system that orders the broad results returned by the search technique for relevancy with respect to the customer-encountered issue.

Turning to FIG. 3B, a flow diagram illustrating a method of updating documentation in accordance with an embodiment is shown. The method may be performed by RMS 104 or other components of the system shown in FIG. 1.

At operation 320, a process used for resolving a service request is documented. The process may be documented by appending or otherwise defining an association between a knowledge base article that resolved a customer-encountered issue with the service request. For example, a repository for the service requests may be updated to reflect the association.

At operation 322, metadata for a knowledge base article used to perform the process to resolve the service request is updated. The updated metadata may be based on the customer-encountered issue. The metadata may be updated by adding a description of the problem stating of the customer-encountered issue using terminology used by a customer that initiated the service request. In this manner, similar descriptions of customer-encountered issues may be used as keys to search metadata for knowledge base articles to identify the portion of the knowledge base articles that may be relevant to resolving the customer-encountered issue.

The method may end following operation 322.

Thus, using the methods illustrated in FIGS. 3A-3B, embodiments disclosed herein may expedite resolution of customer-encountered issues by leveraging historic resolutions to improve the searchability of the knowledge bases as well as improve the ranking of previously performed resolution processes (e.g., documented in knowledge base articles) with respect to new customer-encountered issues.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing customer-encountered issues, the method comprising:
obtaining a service request for a customer-encountered issue of the customer-encountered issues;
obtaining a portion of knowledge base articles that are responsive to a keyword search based on the customer-encountered issue;
ranking the portion of the knowledge base articles based, at least in part, on a quality score of metadata for each knowledge base article of the portion of knowledge base articles to obtain a ranked order; and
resolving the service request using the portion of the knowledge base articles and the ranked order.

2. The method of claim 1, further comprising:
for one of the knowledge base articles of the portion of the knowledge base articles:
comparing metadata for the one of the knowledge base articles to an enumerated list of metadata fields to identify a portion of the metadata fields that are present in the metadata;
calculating a sub-score for each metadata field of the portion of the metadata fields; and
using the sub-scores for the metadata field to obtain the quality score for the one of the knowledge base articles of the portion of the knowledge base articles.

3. The method of claim 2, wherein the metadata fields comprise at least one selected from a list of metadata fields consisting of: a title, a creator, a subject, a description, a publisher, a date, a format, and identifier, a language, and rights.

4. The method of claim 3, wherein ranking the portion of the knowledge base articles comprises:
for the one of the knowledge base articles of the portion of the knowledge base articles:
calculating a ranking score for the one of the knowledge base articles based on the quality score, a use rate score for the one of the knowledge base articles, and an accuracy score for one of the knowledge base articles; and
ordering the one of the knowledge base articles with respect to other knowledge base articles of the portion of the knowledge base articles based on the ranking score and ranking score of the other knowledge base articles.

5. The method of claim 4, wherein resolving the service request comprises:
prompting a service agent to review the portion of the knowledge base articles in an order specified by the ranked order.

6. The method of claim 5, wherein resolving the service request further comprises:
after the customer-encountered issue is resolved using a second one of the knowledge base articles of the portion of the knowledge base articles:
documenting a process performed to resolve the customer-encountered issue based on the second one of the knowledge base articles; and
updating a portion of the metadata that is for the second one of the knowledge base articles based on the customer-encountered issue to obtain updated metadata.

7. The method of claim 6, wherein updating the portion of the metadata comprises:
adding a problem statement to the portion of the metadata, the problem statement comprising terminology used by a customer to initiate the service request.

8. A non-transitory machine-readable medium having instructions stored therein, which when executed by a processor, cause the processor to perform operations for managing customer-encountered issues, the operations comprising:
obtaining a service request for a customer-encountered issue of the customer-encountered issues;
obtaining a portion of knowledge base articles that are responsive to a keyword search based on the customer-encountered issue;
ranking the portion of the knowledge base articles based, at least in part, on a quality score of metadata for each knowledge base article of the portion of knowledge base articles to obtain a ranked order; and
resolving the service request using the portion of the knowledge base articles and the ranked order.

9. The non-transitory machine-readable medium of claim 8, wherein the operations further comprise:
for one of the knowledge base articles of the portion of the knowledge base articles:
comparing metadata for the one of the knowledge base articles to an enumerated list of metadata fields to identify a portion of the metadata fields that are present in the metadata;
calculating a sub-score for each metadata field of the portion of the metadata fields; and
using the sub-scores for the metadata field to obtain the quality score for the one of the knowledge base articles of the portion of the knowledge base articles.

10. The non-transitory machine-readable medium of claim 9, wherein the metadata fields comprise at least one selected from a list of metadata fields consisting of: a title, a creator, a subject, a description, a publisher, a date, a format, and identifier, a language, and rights.

11. The non-transitory machine-readable medium of claim 10, wherein ranking the portion of the knowledge base articles comprises:
for the one of the knowledge base articles of the portion of the knowledge base articles:
calculating a ranking score for the one of the knowledge base articles based on the quality score, a use rate score for the one of the knowledge base articles, and an accuracy score for one of the knowledge base articles; and
ordering the one of the knowledge base articles with respect to other knowledge base articles of the portion of the knowledge base articles based on the ranking score and ranking score of the other knowledge base articles.

12. The non-transitory machine-readable medium of claim 11, wherein resolving the service request comprises:
prompting a service agent to review the portion of the knowledge base articles in an order specified by the ranked order.

13. The non-transitory machine-readable medium of claim 12, wherein resolving the service request further comprises:
after the customer-encountered issue is resolved using a second one of the knowledge base articles of the portion of the knowledge base articles:
documenting a process performed to resolve the customer-encountered issue based on the second one of the knowledge base articles; and
updating a portion of the metadata that is for the second one of the knowledge base articles based on the customer-encountered issue to obtain updated metadata.

14. The non-transitory machine-readable medium of claim 13, wherein updating the portion of the metadata comprises:
adding a problem statement to the portion of the metadata, the problem statement comprising terminology used by a customer to initiate the service request.

15. A data processing system, comprising:
a processor; and
a memory coupled to the processor to store instructions, which when executed by the processor, cause the processor to perform operations for managing remediation of customer-encountered issues, the operations comprising:
obtaining a service request for a customer-encountered issue of the customer-encountered issues;
obtaining a portion of knowledge base articles that are responsive to a keyword search based on the customer-encountered issue;
ranking the portion of the knowledge base articles based, at least in part, on a quality score of metadata for each knowledge base article of the portion of knowledge base articles to obtain a ranked order; and
resolving the service request using the portion of the knowledge base articles and the ranked order.

16. The data processing system of claim 15, wherein the operations further comprise:
for one of the knowledge base articles of the portion of the knowledge base articles:
comparing metadata for the one of the knowledge base articles to an enumerated list of metadata fields to identify a portion of the metadata fields that are present in the metadata;
calculating a sub-score for each metadata field of the portion of the metadata fields; and
using the sub-scores for the metadata field to obtain the quality score for the one of the knowledge base articles of the portion of the knowledge base articles.

17. The data processing system of claim 16, wherein the metadata fields comprise at least one selected from a list of metadata fields consisting of: a title, a creator, a subject, a description, a publisher, a date, a format, and identifier, a language, and rights.

18. The data processing system of claim 17, wherein ranking the portion of the knowledge base articles comprises:
for the one of the knowledge base articles of the portion of the knowledge base articles:
calculating a ranking score for the one of the knowledge base articles based on the quality score, a use rate score for the one of the knowledge base articles, and an accuracy score for one of the knowledge base articles; and
ordering the one of the knowledge base articles with respect to other knowledge base articles of the portion of the knowledge base articles based on the ranking score and ranking score of the other knowledge base articles.

19. The data processing system of claim 18, wherein resolving the service request comprises:
prompting a service agent to review the portion of the knowledge base articles in an order specified by the ranked order.

20. The data processing system of claim 19, wherein resolving the service request further comprises:
after the customer-encountered issue is resolved using a second one of the knowledge base articles of the portion of the knowledge base articles:
documenting a process performed to resolve the customer-encountered issue based on the second one of the knowledge base articles; and
updating a portion of the metadata that is for the second one of the knowledge base articles based on the customer-encountered issue to obtain updated metadata.
